(19) United States
(12) Patent Application Publication
(10) Pub. No.: US 2017/0178249 A1
(43) Pub. Date: Jun. 22, 2017

(54) METHOD AND SYSTEM FOR FACILITATING IDENTIFICATION OF FRAUDULENT TAX FILING PATTERNS BY VISUALIZATION OF RELATIONSHIPS IN TAX RETURN DATA

(71) Applicant: Intuit Inc., Mountain View, CA (US)

(72) Inventors: Thomas M. Pigoski, II, San Francisco, CA (US); Theresa Dayog, Morgan Hill, CA (US); Vivian H. Gerritsen, Palo Alto, CA (US)

(73) Assignee: Intuit Inc., Mountain View, CA (US)

(21) Appl. No.: 14/974,043

(22) Filed: Dec. 18, 2015

(51) Int. Cl. G06Q 40/00; G06Q 50/26

(52) U.S. Cl. CPC G06Q 40/123; G06Q 50/265

(57) ABSTRACT

A method and system provides facilitating identification of fraudulent tax filing patterns. The method and system include receiving historical tax return data and generating a visual representation of the relationships in the tax return data.

### BACKGROUND

Due to the increasing complexity of the tax code, more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, due to the increased ease and accessibility of electronic tax return preparation systems, there is also an increased opportunity for fraudsters to illicitly file false tax returns in order to fraudulently obtain tax refunds.

Fraudsters often steal Social Security numbers and other personally identifying information from unaware victims as part of identity theft. Oftentimes the fraudsters use the Social Security numbers or other personally identifying information to file tax returns in the name of the victim. A victim of identity theft may try to file his own tax return only to find that a fraudster has obtained the victim's Social Security number and has prepared a false tax return in his name in order to get a tax refund. This can cause very distressing problems for the victim as the victim is left to fight an expensive and time-consuming battle to clear up the mess in order to file his own taxes. Additionally, the federal government and state governments are defrauded of the tax refund money that was illegally obtained by the fraudster. Fraudulent tax returns cost federal and state governments billions of dollars each year.

Tax return fraud is not limited to falsely obtaining tax refunds. In some cases fraudsters file tax returns with no refund in order to merely obtain confirmation that they have a name, a social security number, and a birth date that match. In such cases fraudster may contemplate future non-tax related fraudulent activities using the name, social security number, and birth date.

In recent years, there has been a growing trend to implement fraud detection systems within tax preparation systems. These systems are typically based on static rules programmed into the system which generate alerts on specific known patterns of fraud (e.g. a high volume of returns requesting money to be deposited into the same bank account). These rules however only correspond to currently known fraudulent patterns, and are often easily detected by fraudsters, who in turn modify their filing habits to evade detection by the rules. These new patterns are then missed by the rules and may not be detected for some time.

What is needed is a method and system for quickly and easily detecting new and evolving fraudulent tax filing patterns.

### SUMMARY

Embodiments of the present disclosure address some of the shortcomings associated with traditional tax return preparation systems by providing methods and systems for facilitating identification of fraudulent tax filing patterns by visualizing relationships in tax return data. Methods and systems according to the present disclosure generate visual representations of the relationships between selected categories of tax return data. This allows technicians to visually inspect the visual representations and detect previously unnoticed tax filing patterns that indicate fraud. Technicians can then update antifraud detection systems to flag suspicious activity that falls within the newly identified patterns of fraud. In this way, embodiments of the present disclosure address shortcomings of previous fraud detection systems.

In one embodiment, a tax return preparation system utilizes tax return data related to a large number of previously filed tax returns to generate a visual representation of the relationships between selected categories of the tax return data. The tax return preparation system receives visualization parameters from a technician indicating categories and/or particular data points of tax return data to be analyzed. The tax return preparation system then generates the visual representation that displays for the technician the particular relationships between the selected categories and/or data points of the tax return data. The visual representation allows the technician to easily view patterns in tax return preparation and to detect abnormalities related to fraudulent activity. In this way new, emerging, or even previously unnoticed but long used methods of filing fraudulent tax returns can be readily detected. Once the methods and patterns of fraud are understood, appropriate measures can be taken to prevent future fraudulent activity.

In one embodiment, a data acquisition module retrieves the tax return data from one or more internal or external databases. The tax return data can include data related to millions of previously filed tax returns from previous years and/or the current tax year. The data acquisition module can gather the tax return data into a single easily accessible database. The tax return data can include social security numbers, tax filing identifications, user identifications, IP addresses, machine identifications, refund amounts, credit card data used to pay for the tax filings, and bank accounts to which disbursements of refunds were requested.

In one embodiment the data acquisition module provides the tax return data to a visualization generation module. The visualization generation module analyzes the tax return data and generates visualization data that indicates the relationships between selected categories of the tax return data. The visualization data can be an image file, that, when displayed, is the visual representation of the relationships between the selected categories of tax return data.

In one embodiment a technician interface module receives visualization parameter data from a technician computing environment. The visualization parameter data indicates categories of tax return data to be analyzed by the visualization generation module. The visualization parameter data also indicates types of relationships to be analyzed by the visualization generation module. For example, a technician may input visualization parameter data indicating that the visualization generalization module should display relationships between social security numbers, bank accounts, and tax filing identifications. The visualization generation module then generates visualization data that indicates the relationships between the social security numbers, bank accounts, and tax filing identifications. The technician interface module then provides the visualization data to the technician computing environment where the visual representation is displayed for the technician to review. The visualization data may reveal that many social security numbers were each associated with several tax filings and bank accounts. This could possibly indicate fraud.

Embodiments of the present disclosure address some of the shortcomings associated with traditional tax return preparation systems that do not adequately detect fraudulent tax return filings. A tax return preparation system in accordance with one or more embodiments facilitates identification of fraudulent tax filing patterns by generating a visual representation of the relationships between selected categories of tax return data. The various embodiments of the disclosure can be implemented to improve the technical fields of fraud detection, data collection, and data processing. Therefore, the various described embodiments of the disclosure and their associated benefits amount to significantly more than an abstract idea.

Using the disclosed embodiments of a method and system for facilitating identification of fraudulent tax filing patterns, a method and system for facilitating identification of fraudulent tax filing patterns more accurately is provided. Therefore, the disclosed embodiments provide a technical solution to the long standing technical problem of detecting patterns and methods of fraudulent tax return filing.

In addition, the disclosed embodiments of a method and system for facilitating identification of fraudulent tax filing patterns are also capable of dynamically adapting to new methods and patterns of fraudulent tax filing in a changing threat environment. Consequently, the disclosed embodiments of a method and system for facilitating identification of fraudulent tax filing patterns also provide a technical solution to the long standing technical problem of static and inflexible fraudulent tax return detection.

The result is a much more accurate, adaptable, and robust, method and system to detect patterns and methods of fraudulent tax filing, but thereby serves to bolster confidence in electronic tax return preparation. This, in turn, results in: less human and processor resources being dedicated to processing tax return preparations because more accurate and efficient detection methods can be implemented, i.e., fewer false positives having to be processed and/or investigated; less memory and storage bandwidth being dedicated to buffering and storing tax returns incorrectly flagged as potentially fraudulent, i.e., fewer false positives having to be stored while they await further analysis; less communication bandwidth being utilized to transmit tax returns incorrectly designated as potentially fraudulent, i.e., fewer false positives being passed around between various investigating parties and systems.

The disclosed method and system for facilitating identification of fraudulent tax filing patterns does not encompass, embody, or preclude other forms of innovation in the area of fraudulent tax filing detection. In addition, the disclosed method and system for facilitating identification of fraudulent tax filing patterns is not related to any fundamental economic practice, fundamental data processing practice, mental steps, or pen and paper based solutions, and is, in fact, directed to providing solutions to new and existing problems associated with the detection of patterns and methods of fraudulent tax filings. Consequently, the disclosed method and system for facilitating identification of fraudulent tax filing patterns is not directed to, does not encompass, and is not merely, an abstract idea or concept.

### BRIEF DESCRIPTION OF THE DRAWINGS

FIG. 1 is a block diagram of software architecture for facilitating identification of fraudulent tax filing patterns, in accordance with one embodiment.

FIG. 2 is a block diagram of a process for facilitating identification of fraudulent tax filing patterns, in accordance with one embodiment.

FIG. 3 is a flow diagram of a process for facilitating identification of fraudulent tax filing patterns, in accordance with one embodiment.

FIG. 4 is a visual representation of relationships between tax return data, in accordance with one embodiment.

FIG. 5 is a visual representation of relationships between tax return data, in accordance with one embodiment.

FIG. 6 is a visual representation of relationships between tax return data, in accordance with one embodiment.

FIG. 7 is a visual representation of relationships between tax return data, in accordance with one embodiment.

Common reference numerals are used throughout the FIGS. and the detailed description to indicate like elements. One skilled in the art will readily recognize that the above FIGS. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be implemented in many different forms and should not be construed as limited to the embodiments set forth herein, shown in the FIGS., and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for facilitating identification of fraudulent tax filing patterns by generating a visual representation of relationships between tax return data, according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed tax return preparation system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the terms “interview” and “interview process” include, but are not limited to, an electronic, software-based, and/or automated delivery of multiple questions to a user and an electronic, software-based, and/or automated receipt of responses from the user to the questions, according to various embodiments.

### Hardware Architecture

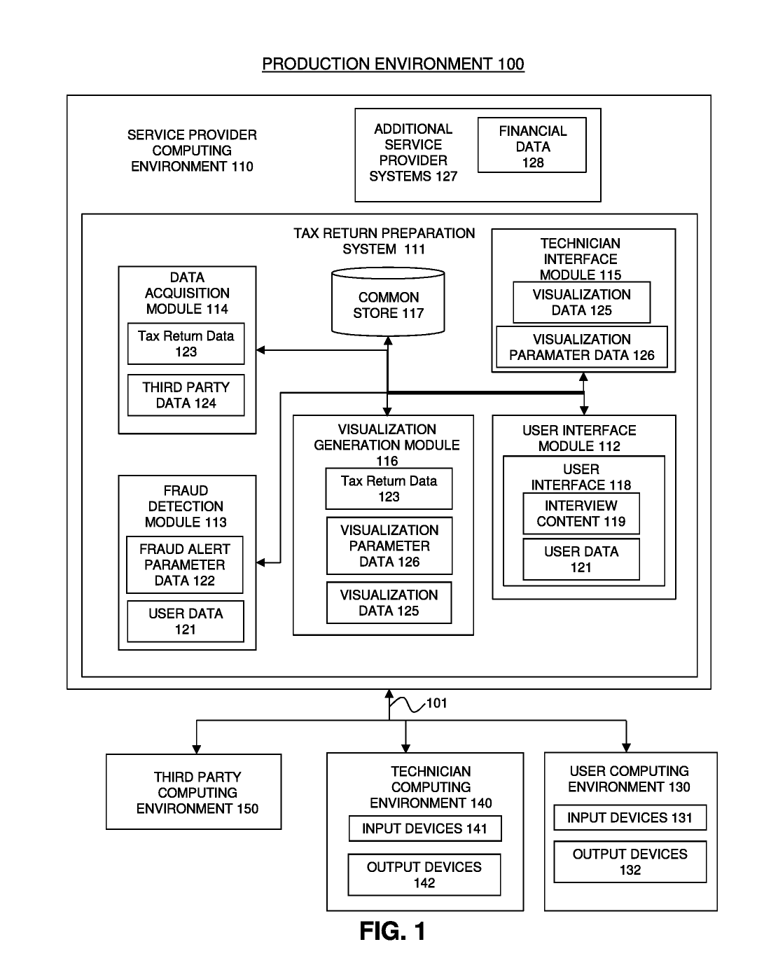

FIG. 1 illustrates a block diagram of a production environment 100 for facilitating identification of fraudulent tax filing patterns, according to one embodiment. Embodiments of the present disclosure provide methods and systems for facilitating identification of fraudulent tax filing patterns, according to one embodiment. The method and system receives, with a data acquisition module of the computing system, tax return data related to a plurality of previously filed tax returns. The method and system receives, with a technician interface module of the computing system, visualization parameter data from a technician. The method and system generates, with a visualization generation engine of the computing system, visualization data for a visual representation of relationships between the tax return data based on the visualization parameter data. The method and system outputs, with the technician interface module, the visualization data.

In addition, the disclosed method and system for facilitating identification of fraudulent tax filing patterns provides for significant improvements to the technical fields of fraud prevention, electronic transaction data processing, data processing, data management, and user experience.

In addition, as discussed above, the disclosed method and system for facilitating identification of fraudulent tax filing patterns provides for the entry, processing, and dissemination, of only relevant portions of data, i.e., more accurately identified potentially fraudulent tax returns; thereby eliminating unnecessary data analysis and correction before resources are allocated to processing, and/or correcting, faulty data, and/or the faulty data is further transmitted/distributed. Consequently, using the disclosed method and system for facilitating identification of fraudulent tax filing patterns results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for facilitating identification of fraudulent tax filing patterns

The production environment 100 includes a service provider computing environment 110, a user computing environment 130, a technician computing environment 140, and a third party computing environment 150, according to one embodiment. The computing environments 110, 130, 140, and 150 are communicatively coupled to each other with one or more communication channels 101, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, for facilitating identification of fraudulent tax filing patterns, according to one embodiment. The service provider computing environment 110 represents a traditional data center computing environment, a virtual asset computing environment (e.g., a cloud computing environment), or a hybrid between a traditional data center computing environment and a virtual asset computing environment, according to one embodiment.

The service provider computing environment 110 includes a tax return preparation system 111, which is configured to facilitate preparation of tax returns and to facilitate identification of fraudulent tax filing patterns. The tax return preparation system 111 can be a standalone system. Alternatively, the tax return preparation system 111 can be integrated into other software or service products provided by a service provider.

The tax return preparation system 111 assists users in preparing their tax returns. The tax return preparation system 111 also facilitates the detection of fraudulent tax return preparation patterns by receiving and analyzing data related to previously filed tax returns and previously disbursed tax refunds. The tax return preparation system 111 includes various components, databases, engines, modules, and/or data to facilitate the detection of fraudulent tax return preparation patterns.

The tax return preparation system 111 includes a user interface module 112, a fraud detection module 113, a data acquisition module 114, a technician interface module 115, and a visualization generation module 116, according to one embodiment.

The user interface module 112 guides a user through a series of tax return preparation topics by asking questions or by inviting the user to provide data related to tax return preparation topics selected by the user. The user interface module 112 includes a user interface 118, according to one embodiment. The user interface module 112 provides interview content 119 including a number of questions and/or financial topics that can be presented with one or more user experience elements, according to one embodiment. The user experience elements include, but are not limited to, buttons, slides, dialog boxes, text boxes, drop-down menus, banners, tabs, directory trees, links, audio content, video content, and/or other multimedia content for facilitating preparation of a tax return.

The user computing environment 130 includes input devices 131 and output devices 132 for communicating with the tax filer, according one embodiment. The input devices 131 include, but are not limited to, keyboards, mice, microphones, cameras, touchpads, touchscreens, digital pens, and the like. The output devices 132 include, but are not limited to, speakers, monitors, touchscreens, and the like.

Returning to the tax return preparation system 111, the user interface module 112 is configured to receive user data 121 from the user computing environment 130. The user data 121 can include a social security number, a user identification, a home address, a business address, an IP address, a device identification such as MAC address, a first name, a last name, a state from which the user is filing, an email address, a phone number, and other data related to the preparation of the tax returns. Based on the user data 121, the tax return preparation system indicates whether the user needs to pay additional taxes or whether the user is entitled to a tax refund.

The fraud detection module 113 is implemented to assist in the detection of fraud based on the user data 121 and fraud alert parameter data 122. For example, the fraud detection module 113 is configured to analyze the user data 121 provided by the user and to flag the user data 121 as suspicious based on the fraud alert parameter data 122. For example, based on previous experiences, the fraud alert parameter data 122 can flag as suspicious user data 121 that indicates that the user should receive an abnormally large tax refund. The tax fraud alert parameters data 122 can flag fraud based on multiple uses of a Social Security number, use of a Social Security number that has been flagged as compromised, etc. When the fraud detection module 113 detects suspicious activity, the fraud detection module 113 can either cause the user interface module 113 to interrupt the tax return preparation interview by asking the user for clarifying data or by indicating to the user that a possible error has made in the tax return preparation process. Additionally, the fraud detection module 113 can indicate to technician or even to authorities that the current tax return should be investigated for possible fraud.

Unfortunately, it can be very difficult to keep up with the methods used by fraudsters to fraudulently obtain tax refunds. In particular, the fraud alert parameter data 122 can be inadequate or outdated due to the fact that fraudsters are constantly developing new methods to fraudulently obtain tax refunds.

The visualization generation module 116 can assist the tax return preparation system 111 in keeping up-to-date with the methods used by fraudsters to fraudulently obtain tax refunds. In particular, the visualization generation module 116 can generate a visual representation of the relationships between data points of the tax return data 123. The visual representation can be studied by technicians in order to detect abnormal relationships displayed in the visual representations. For example, the visual representation can show that in most cases of legitimate tax return preparation, a single Social Security number is linked to a single tax filing and a single bank account. Among the visual representation perhaps the majority of Social Security numbers will be linked to a single bank account to a single tax filing. However, other Social Security numbers may be linked to multiple filings and multiple bank accounts. This could indicate a pattern of fraud. A technician of the tax return preparation system 111 can study the visual representation in order to detect abnormal and possibly fraudulent filing relationship patterns. In this way, the visualization generation module 116 can assist the tax return preparation system 111 in keeping up-to-date with methods and patterns used by fraudsters to fraudulently obtain tax refunds.

Accordingly, the data acquisition module 113 is configured to acquire historical tax return data 123 and provide it to the visualization generation module 116, according to one embodiment. The data acquisition module 114 can itself be the repository of tax returns previously prepared by the tax return preparation system 111. Thus, the tax return data 123 can include data related to millions of previously prepared tax returns. The previously prepared tax returns can include tax returns prepared for the current tax year as well as tax returns prepared in previous tax years. Additionally or alternatively, the data acquisition module 114 can communicate with additional service provider systems 127, e.g., an expense management system, a payroll system, or other financial management system, to retrieve or supplement the tax return data 123 by importing financial data 128 from the additional service provider systems 127. Thus, the financial data 128 can include tax return preparation data, personal financial data, bank account data, credit card data or other data that can be used to supply and/or supplement the tax return data 123, according to one embodiment. The data acquisition module 113 imports relevant portions of the financial data 128 and, for example, saves local copies into one or more databases, according to one embodiment.

According to one embodiment, the data acquisition module 114 can obtain some or all of the tax return data 123 from the common store 117. The common store 117 can include one or more databases in which tax return data is stored. The common store 117 can also store other data that can supplement the tax return data 123 acquired by the data acquisition module 114.

In one embodiment, the data acquisition module 114 is configured to acquire additional data third party data 124 related to the tax return data 123 from the third-party computing environment 150. The third party data 124 can be gathered from public record searches of tax records, public information databases, public maps, property ownership records, and other public sources of information. The data acquisition module 113 can also acquire data from sources such as social media websites, such as Twitter, Facebook, LinkedIn, and the like. The data acquisition module 114 can request and receive third party data 124 from the third party computing environment 150 to supply or supplement the tax return data 123, according to one embodiment. In one embodiment, the third party computing environment 150 is configured to automatically transmit data to the tax return preparation system 111 (e.g., to the data acquisition module 114), to be merged into the third party data 124 and the tax return data 123. The third party computing environment 150 can include, but is not limited to, financial service providers, state institutions, federal institutions, third party databases that provide location data or data indicating a business or type of business that operates at a particular location, financial institutions, social media, and any other business, organization, or association that has maintained, that currently maintains, or which may in the future maintain data relevant to the tax return data 123, according to one embodiment.

According to an embodiment, the tax return data 123 can include data that identifies tax payers such as first names, last names, social security numbers, birth dates, street addresses, email addresses, phone numbers, etc. The tax return data can also include data that identifies tax preparers such as User IDs, preparer email addresses, preparer contact phone numbers, IP addresses, device identifications, etc. The tax return data can also include income and expense data such as employment data, income data, expense data, taxes withheld, etc. The tax return data 123 can also include tax refund request data such as refund methods, refund amounts, refund bank accounts, refund addresses for those that request refund checks, etc. The tax return data 123 can include return payment data such as payment methods, credit cards used, bank accounts used, etc. All of these types of user data can analyzed to detect patterns of fraud by generating visual representations of the relationships between selected data points or categories in the tax return data 123.

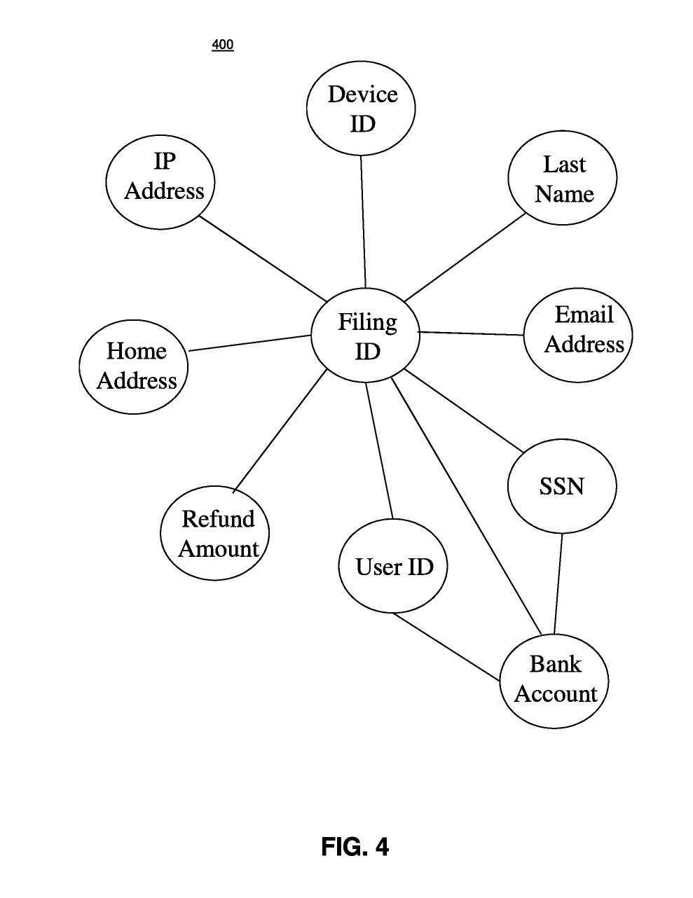

Tax return preparation system 111 uses the technician interface module 115 to obtain visualization parameter data 126 for the visualization generation module 116. In particular, the technician interface module 115 enables a technician to input selected visualization parameter data 126 into the technician interface module 115. The visualization parameter data 126 is selected by a technician to refine or adjust a visual representation output by the visualization generation module 116. For example, as one or more technicians study a visual representation of the relationships between tax filings, bank accounts used to receive tax refunds, and identifiers from the previously prepared tax returns, the technicians may refine the parameters for the visual representation. For example, a technician may want the visual representation to show only Social Security numbers linked with four or more bank accounts. Thus, the technician can enter visualization parameter data 126 indicating that the visualization generation module 116 to generate a visual representation showing only Social Security numbers linked to four or more bank accounts. The types of visualization parameter data 126 is explained in more detail with respect to FIGS. 4 through 7.

According to an embodiment, the technician interface module 115 interfaces with a technician computing environment 140. The technician computing environment 140 is operated by the technician both to input visualization parameter data 126 and to display the visual representations. Accordingly, the technician computing environment 140 includes input devices 141 and output devices 142. The input devices 141 can include, but are not limited to, keyboards, mice, microphones, cameras, touchpads, touchscreens, digital pens, or any other suitable device for enabling a technician to input data that will be transmitted to the technician interface module 115. The output devices 142 include, but are not limited to, speakers, monitors, touchscreens, or other devices that enable the technician to view the visual representation received from the technician interface module 115. In particular, the output devices 142 can include a display by which the visual representation can be displayed to the technician for analysis. While FIG. 1 illustrates a technician computing environment 140 outside of the service provider computing environment 110, the technician computing environment 140 can be a part of the service provider computing environment 110.

The visualization generation module 116 receives the tax return data 123 from the data acquisition module 114. The visualization generation module 116 also receives the visualization parameter data 126 from the technician interface module 115. The visualization generation module generates visualization data 125 based on the tax return data 123 and the visualization parameter data 126. The visualization generation module 116 therefore has access to the tax return data 123 related to millions of previously filed tax returns. The visualization generation module 116 can, in theory, generate a visual representation of all the relationships between the various data points in the tax return data 123. Such a visual representation could include billions of data points and their interconnections. However, the visualization parameter data 126 enables a technician to define what kinds of relationships and how many data points and relationships should be shown in the visual representation. Based on the visualization parameter data 126, the visualization generation module 116 generates visualization data 125 showing the selected number and types of relationships. The visualization data 125 can correspond to an image file or other type of data that when processed, cause the output device 142 to display the visual representation. Thus, when the visualization generation module 116 generates visualization data 125, the visualization generation module 116 sends the visualization data 125 to the technician interface module 115. The technician interface module 115 transmits the visualization data 125 to the technician computing environment 140 which then converts the visualization data 125 into the visual representation which can be viewed by the technician via the output devices 142 of the technician computing environment 140. In this way, the visualization generation module 146 generates a visual representation based on the tax return data 123 and the visualization parameter data 126.

According to an embodiment, the visual representation illustrates several nodes as well as their connections to each other. The nodes correspond to the selected aspects of the tax return data 123. The nodes can include a device ID related to a specific computing device used by a user to prepare a tax return, a client IP address associated with one or more devices used by the user to prepare a tax return, a Social Security number of the user or the spouse or dependent of the user, a first name of the user, a last name of a user, a particular filing number identifier related to the filing of the tax return, a user ID associated with the user, an email address of the user, a mailing or business address of the user, a phone number of the user, an employer of the user, bank account data, tax refund amount data or any other information included in the tax return data 123. In the visual representation, each node could include a circle with an identifier identifying the node as a particular Social Security number, bank account number, filing, device ID etc.

The relationships between nodes can be represented by connecting lines that extend between nodes. For example, if a technician wanted to see the relationship between a particular Social Security number and any bank accounts, device IDs, and filings associated with the Social Security number, then the technician can enter visualization parameter data 126 accordingly. The visualization generation module 116 then generates visualization data 125 that shows a node representing the Social Security number (e.g. a circle with a social security identifier therein) and nodes representing one or more bank accounts, device IDs, and filings that are associated with that Social Security number. These additional nodes could also be circles or other shapes including identifiers therein. Connecting lines can extend between the Social Security number node and all the other nodes. Such visualization parameter data 126 may cause the visualization generation module 116 to generate visualization data 125 showing that there are dozens of bank accounts, device IDs, and filings each related to the Social Security number. This can possibly be an indication of fraud. Those of skill in the art will recognize that other types of visualization can be implanted in accordance with principles of the present disclosure. All such other types of visualization of data and relationships fall within the scope of the present disclosure.

According to an embodiment, the visualization generation module 116 can be utilized to generate multiple successive visual representations based on iterations in the visual parameter data 126. For example, a technician may enter visualization parameter data 126, the visualization generation module 116 may generate visualization data 125 based on the visualization parameter data 126, and the user may view the visual representations and may wish to see a slight variation of it. The technician may then enter additional visualization parameter data 126 to refine or alter the visual representation in order to further investigate a particular type of pattern. The visualization generation module 116 will then generates new visualization data 125 based on the updated visualization parameter data 126. In this way, the visualization generation module 116 can provide multiple successive visualization data 125 based on updated visualization parameter data 126.

As new tax returns are continuously being prepared and filed during a tax return preparation season the data acquisition module 114 can continually update the tax return data 123 by retrieving data related to recently filed tax returns and recently dispersed tax refunds. For example, the data acquisition module 114 can update the tax return data 123 and third party data 124 daily, biweekly, weekly, monthly, etc. in order to keep the tax return data 123 used by the visualization generation module 116 up-to-date.

According to an embodiment, the visualization parameter data 126 can include data indicating that only tax return data 123 from a particular time period be used by the visualization generation module 116 in generating new visualization data 125. For example, a technician may wish to investigate emerging fraudulent filing patterns representing new methods in use by fraudsters. In this case, the technician can input visualization parameter data 126 to the technician interface module 115 causing the visualization generation module 116 to generate visualization data 125 using only tax return data 123 from the previous two week period. The visualization generation module 116 would then generate visualization data 125 using tax return data 123 gathered only in the previous two weeks. In this way, the technician can investigate emerging patterns of fraud.

When new and emerging patterns of fraud are identified based on the visualization data 125 generated by the visualization generation module 116, the fraud detection module 113 can be updated to flag suspicious tax returns. In particular, a technician can use the technician interface module 115 to provide new fraud alert parameter data 122 to the fraud detection module 113. The fraud detection module 113 therefore updates the fraud alert parameters data 122 to flag tax returns that include characteristics of fraudulent patterns or methods as identified based on the visualization data 125. Furthermore, the fraud detection module 113 can scan previously filed tax returns based on updated fraud alert parameters data 122 to flag tax returns that indicate the use of newly identified patterns or methods of fraud. The tax return preparation system 111 can provide information to federal and state authorities identifying tax returns that include suspicious characteristics.

Embodiments of the present disclosure address some of the shortcomings associated with traditional tax return preparation systems that do not adequately identify fraudulent tax returns. A tax return preparation system in accordance with one or more embodiments facilitates detecting fraudulent tax return filings by generating a visual representation of relationships between previous tax return data and previous tax return filings. The various embodiments of the disclosure can be implemented to improve the technical fields of user experience, data collection, and data processing. Therefore, the various described embodiments of the disclosure and their associated benefits amount to significantly more than an abstract idea. In particular, by generating a visual representation of relationships between historical tax return data this, technicians can more readily identify patterns of fraudulent tax return filings. The knowledge of these patterns is in turn used to update fraud detection modules that detect fraud in real time. In this way, fewer data processing resources are used in detecting fraud because the fraud detection modules are more accurate and efficient. This can save users can save money and time and reduce the amount of money stolen from federal and state governments by fraudsters.

### Process

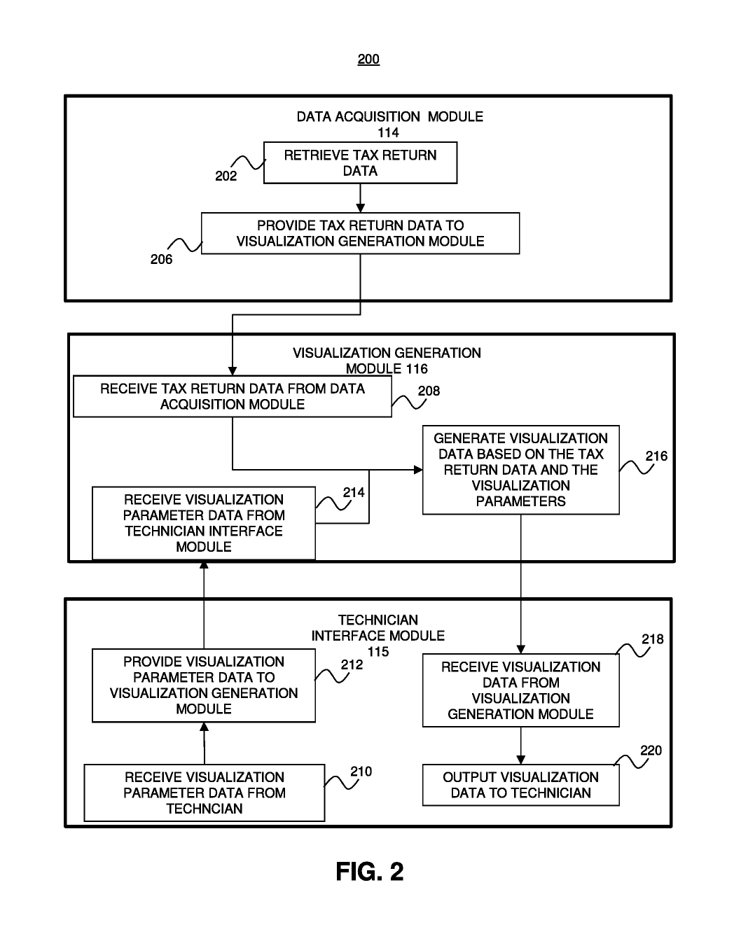

FIG. 2 illustrates a functional flow diagram of a process 200 for facilitating identification of fraudulent tax filing patterns, in accordance with one embodiment.

At block 202, the data acquisition module 114 receives tax return data related to previously filed tax returns. The data acquisition module 114 can receive the tax return data from an internal or external database. The process proceeds to block 206.

At block 206 the data acquisition module 114 provides the tax return data to the visualization generation module 116. From block 206, the process proceeds to block 208.

At block 208, the visualization generation module 116 receives the tax return data from the data acquisition module 114.

At block 210, the technician interface module 115 receives visualization parameter data from a technician, according to one embodiment. From block 210, the process proceeds to block 212.

At block 212, the technician interface module 115 provides the visualization parameter data to the visualization generation module 116, according to one embodiment. From block 212 the process proceeds to block 214.

At block 214 the visualization generation module 116 receives the visualization parameter data from the technician interface module 115. From block 214 the process proceeds to block 216.

At block 216 the visualization generation module 116 generates visualization data based on the tax return data and the visualization parameters. From block 216 the process proceeds to block 218.

At block 218 the technician interface module 115 receives visualization data from the visualization generation module 116. From block 218 the process proceeds to block 220.

At block 220 the technician interface module 115 outputs the visualization data to a technician.

Although a particular sequence is described herein for the execution of the process 200, other sequences can also be implemented.

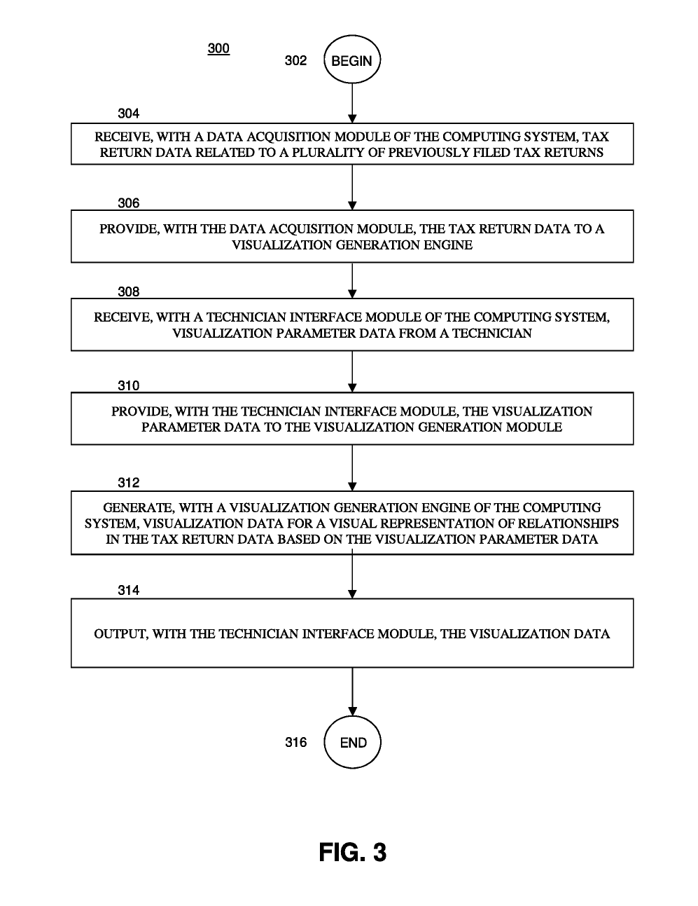

FIG. 3 illustrates a flow diagram of a process 300 for facilitating identification of fraudulent tax filing patterns, according to various embodiments.

In one embodiment, process 300 for facilitating identification of fraudulent tax filing patterns begins at BEGIN 302 and process flow proceeds to RECEIVE, WITH A DATA ACQUISITION MODULE OF THE COMPUTING SYSTEM, TAX RETURN DATA RELATED TO A PLURALITY OF PREVIOUSLY FILED TAX RETURNS 304.

In one embodiment, at RECEIVE, WITH A DATA ACQUISITION MODULE OF THE COMPUTING SYSTEM, TAX RETURN DATA RELATED TO A PLURALITY OF PREVIOUSLY FILED TAX RETURNS 304 process 300 for facilitating identification of fraudulent tax filing patterns, receives, with a data acquisition module of the computing system, tax return data related to a plurality of previously filed tax returns.

In one embodiment, once process 300 for facilitating identification of fraudulent tax filing patterns receives, with a data acquisition module of the computing system, tax return data related to a plurality of previously filed tax returns at RECEIVE, WITH A DATA ACQUISITION MODULE OF THE COMPUTING SYSTEM, TAX RETURN DATA RELATED TO A PLURALITY OF PREVIOUSLY FILED TAX RETURNS 304 process flow proceeds to PROVIDE, WITH THE DATA ACQUISITION MODULE, THE TAX RETURN DATA TO A VISUALIZATION GENERATION ENGINE 306.

In one embodiment at PROVIDE, WITH THE DATA ACQUISITION MODULE, THE TAX RETURN DATA TO A VISUALIZATION GENERATION ENGINE 306 process 300 for facilitating identification of fraudulent tax filing patterns provides, with the data acquisition module, the tax return data to a visualization generation engine.

In one embodiment, once process 300 for facilitating identification of fraudulent tax filing patterns provides, with the data acquisition module, the tax return data to a visualization generation engine at PROVIDE, WITH THE DATA ACQUISITION MODULE, THE TAX RETURN DATA TO A VISUALIZATION GENERATION ENGINE 306 process flow proceeds to RECEIVE, WITH A TECHNICIAN INTERFACE MODULE OF THE COMPUTING SYSTEM, VISUALIZATION PARAMETER DATA FROM A TECHNICIAN 308.

In one embodiment, at RECEIVE, WITH A TECHNICIAN INTERFACE MODULE OF THE COMPUTING SYSTEM, VISUALIZATION PARAMETER DATA FROM A TECHNICIAN 308, process 300 for facilitating identification of fraudulent tax filing patterns receives, with a technician interface module of the computing system, visualization parameter data from a technician, according to one embodiment.

In one embodiment, once process 300 for facilitating identification of fraudulent tax filing patterns receives, with a technician interface module of the computing system, visualization parameter data from a technician at RECEIVE, WITH A TECHNICIAN INTERFACE MODULE OF THE COMPUTING SYSTEM, VISUALIZATION PARAMETER DATA FROM A TECHNICIAN 308, process flow proceeds to PROVIDE, WITH THE TECHNICIAN INTERFACE MODULE, THE VISUALIZATION PARAMETER DATA TO THE VISUALIZATION GENERATION MODULE 310.

In one embodiment at PROVIDE, WITH THE TECHNICIAN INTERFACE MODULE, THE VISUALIZATION PARAMETER DATA TO THE VISUALIZATION GENERATION MODULE 310, process 300 for facilitating identification of fraudulent tax filing patterns provides, with the technician interface module, the visualization parameter data to the visualization generation module.

In one embodiment, once process 300 for facilitating identification of fraudulent tax filing patterns provides, with the technician interface module, the visualization parameter data to the visualization generation module at PROVIDE, WITH THE TECHNICIAN INTERFACE MODULE, THE VISUALIZATION PARAMETER DATA TO THE VISUALIZATION GENERATION MODULE 310, process flow proceeds to GENERATE, WITH A VISUALIZATION ENGINE OF THE COMPUTING SYSTEM, VISUALIZATION DATA FOR A VISUAL REPRESENTATION OF RELATIONSHIPS IN THE TAX RETURN DATA BASED ON THE VISUALIZATION PARAMETER DATA 312.

In one embodiment, at GENERATE, WITH A VISUALIZATION GENERATION ENGINE OF THE COMPUTING SYSTEM, VISUALIZATION DATA FOR A VISUAL REPRESENTATION OF RELATIONSHIPS IN THE TAX RETURN DATA BASED ON THE VISUALIZATION PARAMETER DATA 312 the process 300 generates, with a visualization generation engine of the computing system, visualization data for a visual representation of relationships in the tax return data based on the visualization parameter data.

In one embodiment, once process 300 generates, with a visualization generation engine of the computing system, visualization data for a visual representation of relationships in the tax return data based on the visualization parameter data at GENERATE, WITH A VISUALIZATION GENERATION ENGINE OF THE COMPUTING SYSTEM, VISUALIZATION DATA FOR A VISUAL REPRESENTATION OF RELATIONSHIPS IN THE TAX RETURN DATA BASED ON THE VISUALIZATION PARAMETER DATA 312, process flow proceeds to OUTPUT, WITH THE TECHNICIAN INTERFACE MODULE, THE VISUALIZATION DATA 314.

In one embodiment, at OUTPUT, WITH THE TECHNICIAN INTERFACE MODULE, THE VISUALIZATION DATA 314 the process 300 for facilitating identification of fraudulent tax filing patterns receives outputs, with the technician interface module, the visualization data.

In one embodiment, once the process 300 for facilitating identification of fraudulent tax filing patterns receives outputs, with the technician interface module, the visualization data at OUTPUT, WITH THE TECHNICIAN INTERFACE MODULE, THE VISUALIZATION DATA, process flow process flow proceeds to END 316.

In one embodiment, at END 316 the process for facilitating identification of fraudulent tax filing patterns receives is exited to await new data and/or instructions.

FIG. 4 is an example of a visual representation 400 of relationships between tax return data, according to one embodiment. The visual representation 400 includes a plurality of nodes representing various types of tax return data. Each of the nodes includes a circle with a text description of the node within the circle. The nodes include device ID, IP address, home address, refund amount, user ID, bank account number, Social Security number (SSN), email address, and last name.

In the example of FIG. 4, visualization parameter data has been entered by a technician. The visualization parameter data input by the technician include a request to visualize a particular filing ID and each of the IP address, device ID, home address, refund amount, user ID, Social Security number, bank account, email address, and last names associated with the particular filing ID. The visualization generation engine generates the visual representation 400 including the particular filing ID and all the selected types of nodes that are related to the particular filing ID. In the example of FIG. 4, the filing ID is related to only one node of each type of data. In other words, the particular filing ID is related to a single IP address, a single device ID, a single last name, a single email address, a single Social Security number, a single bank account, a single user ID, a single refund amount, and a single address. The relationships are indicated by a straight line connecting the filing ID to each of the related nodes.

In the example of FIG. 4, the tax return data includes the filing ID, device ID, the last name, email address, the Social Security number, the user ID, refund amount, the home address, and IP address. The tax return data includes the bank account, the user ID, the Social Security number, and the filing ID. The visualization generation module generates the visual representation 400 based on the tax return data in view of the visualization parameters data input by the technician. In the case of FIG. 4, the visualization indicates a normal tax return preparation filing unlikely to be associated with fraud because the visualization is consistent with a single individual filing a single tax return related to a single bank account and a single Social Security number.

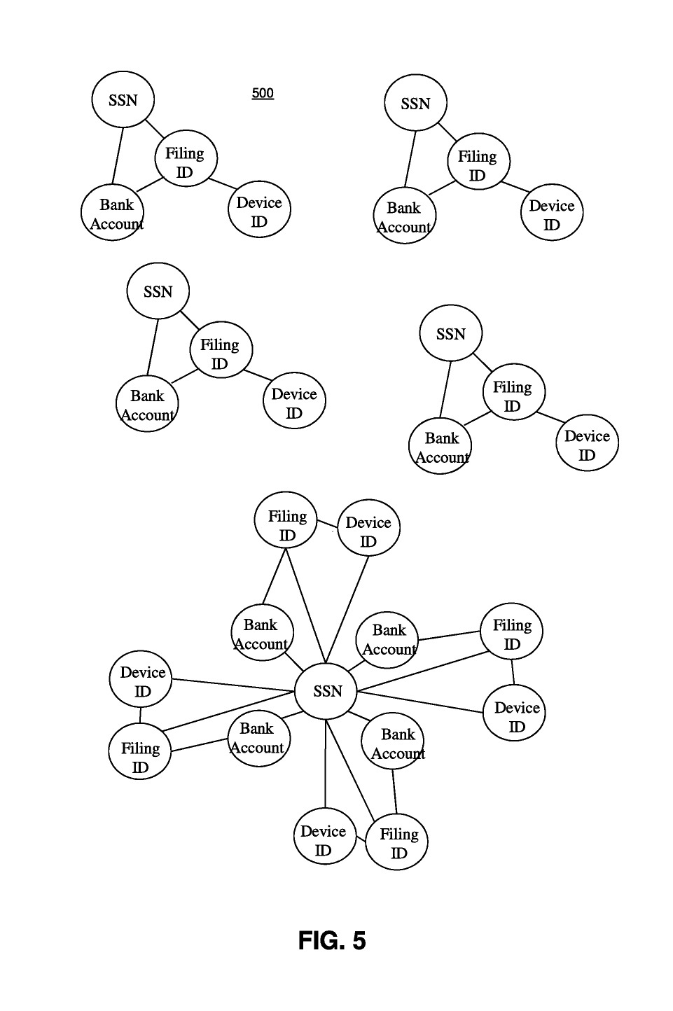

FIG. 5 is an example of a visual representation 500 of the relationships between tax return data, according to one embodiment. The visual representation 500 is an example in which the technician has input visualization parameter data that will show filing IDs, Social Security numbers, bank accounts, device IDs, and their relationships to each other. If no limit is placed on the number of nodes that can be shown in the visual representation 500, then the visualization generation module may attempt to show all of the Social Security numbers, bank accounts, filing IDs, and device IDs and their relationships based on the tax data. However, according to an embodiment, the input technician can select a maximum number of nodes to be shown. In FIG. 5, 29 nodes are shown. This can be an example of a technician including in the visualization parameter data that fewer than 30 nodes should be shown.

The visualization generation module has generated a visualization 500 that includes five groups of nodes. Four of the groups of nodes include a single Social Security number, a single bank account, a single filing ID, and a single device ID. This represents the most common type of tax filer in which a single individual using a single computing device files a single tax return with the tax refund going to a single bank account linked to his or her Social Security number. However, the fifth group shows a single Social Security number related to four different filings, each prepared on a different device and including respective tax refunds being deposited to respective bank accounts. Because a single Social Security number has been used in four different filings, it is likely that the Social Security number has been compromised and has been used to file for different tax returns. By studying the visualization 500, a technician can come to understand a certain pattern of fraudulent activity.

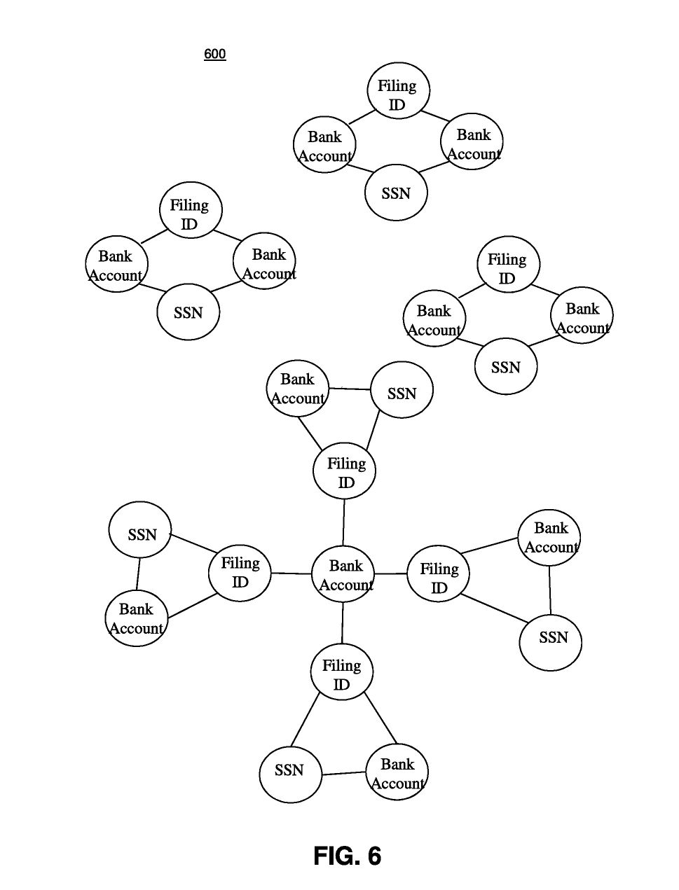

FIG. 6 is a visual representation 600 illustrating relationships between various types of tax return data, according to an embodiment. In the example of FIG. 6, a technician has input visualization parameter data selected to return filing identifications and Social Security numbers linked to at least two bank accounts. The visualization 600 shows four groups of connected nodes. Three of the groups include a single Social Security number and a single filing ID each link to two bank accounts. This may not be a suspicious pattern because it is fairly common for an individual tax preparer to have a portion of her tax refund go to two different bank accounts. The three small groups of the visualization 600 are representative of this situation. However, the fourth larger group in the visualization 600 includes a single bank account related to four filing IDs. Each of the filing IDs is related to an additional bank account and Social Security number. Upon first glance this larger group is suspicious because it is very different from the more common small groups. Nevertheless this may represent a situation in which multiple tax preparers have each retained the assistance of another individual to help them use the tax preparation systems to prepare and file their taxes. As payment, the tax preparer has diverted some of the tax refund to his bank account. While this may be against the terms of service of the tax preparation system, this nevertheless may not represent the kind of fraud that harms state and federal governments and other tax preparers. However, if a technician wishes to flag such filings as suspicious, the technician can update the fraud detection parameters of the fraud detection module to flag any bank account that is related to five or more filings. Those of skill in the art will understand, in light of the present disclosure, that many inferences can be drawn by studying visualizations of the relationships between tax data and refund data.

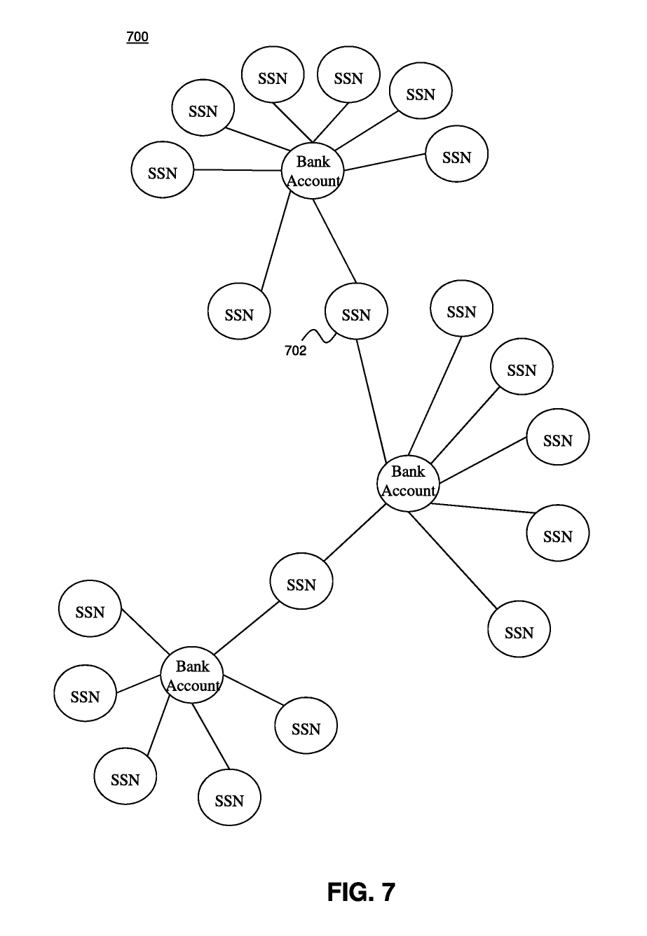

FIG. 7 is a visual representation 700 of the relationship between tax data, according to an embodiment. In the example of FIG. 7, the technician has input visualization parameter data directed to show a particular known compromised Social Security number 702 and the bank accounts that are related to the compromised Social Security number 702 as well as the Social Security numbers related to the bank accounts. The visual representation 700 shows three bank accounts related to the compromised Social Security number 702. Each of the three bank accounts is related to at least six Social Security numbers. This likely represents one or more fraudsters using one or more bank accounts to obtain fraudulent tax refunds using many compromised Social Security numbers. Thus, by starting from a single known compromised Social Security number 702, many more likely compromised Social Security numbers can be identified in addition to bank accounts almost certainly related to fraud. In this case, a technician can update the fraud protection parameters to flag any bank account related to more than four Social Security numbers. Additionally, the fraud detection parameters can be updated to flag any tax return associated with the particular Social Security numbers returned in the visual representation 700 and the bank accounts. Thus, if additional fraudulent tax returns are prepared in relations to the compromised Social Security numbers and bank accounts, those returns can be flagged as suspicious.

Visualization parameter data can be altered and the visual representations studied by technicians in order to identify more suspicious or fraudulent patterns of relationships in tax return data. By encountering unusual patterns while studying visual representations generated by the visualization generation module, technicians can learn about new methods used by fraudsters. With new knowledge, the technicians can update the fraud detection parameters then flag suspicious activity that coincides with the new knowledge gained with the aid of the visualizations.

In one embodiment, a computing system implemented method for facilitating identification of fraudulent tax filing patterns includes receiving, with a data acquisition module of the computing system, tax return data related to a plurality of previously filed tax returns, and providing, with the data acquisition module, the tax return data to a visualization generation engine. The method further includes receiving, with a technician interface module of the computing system, visualization parameter data from a technician, and providing, with the technician interface module, the visualization parameter data to the visualization generation module. The method further includes generating, with a visualization generation module of the computing system, visualization data for a visual representation of relationships in the tax return data based on the visualization parameter data, and outputting, with the technician interface module, the visualization data.

One embodiment is a non-transitory computer-readable medium having a plurality of computer-executable instructions which, when executed by a processor, perform a method facilitating identification of fraudulent tax filing patterns. The instructions include a data acquisition module configured to retrieve tax return data, the tax return data being related to previously filed tax returns. The instructions also include a technician interface module configured to receive visualization parameter data from a technician. The instructions further include a visualization generation module configured to generate a visualization data based on the tax return data and the visualization parameter data, the visualization data corresponding to a visual representation of relationships in the tax return data in accordance with the visualization parameters.

One embodiment is a system for facilitating identification of fraudulent tax filing patterns. The system includes at least one processor and at least one memory coupled to the at least one processor, the at least one memory having stored therein instructions which, when executed by any set of the one or more processors, perform a process. The process includes receiving, with a data acquisition module of the computing system, tax return data related to a plurality of previously filed tax returns, receiving, with the data acquisition module of the computing system, and receiving, with a technician interface module of the computing system, visualization parameter data from a technician. The process further includes generating, with a visualization engine of the computing system, visualization data for a visual representation of relationships in the tax return data based on the visualization parameter data and outputting, with the technician interface module, the visualization data.

Embodiments of the present disclosure address some of the shortcomings associated with traditional tax return preparation systems that do not adequately identify fraudulent tax returns. A tax return preparation system in accordance with one or more embodiments facilitates detecting fraudulent tax return filings by generating a visual representation of relationships between previous tax return data and previous tax return filings. The various embodiments of the disclosure can be implemented to improve the technical fields of user experience, data collection, and data processing. Therefore, the various described embodiments of the disclosure and their associated benefits amount to significantly more than an abstract idea. In particular, by generating a visual representation of relationships in historical tax return data technicians can more readily identify patterns of fraudulent tax return filings. The knowledge of these patterns is in turn used to update fraud detection modules that detect fraud in real time. In this way, fewer data processing resources are used in detecting fraud because the fraud detection modules are more accurate and efficient. This can save users can save money and time and reduce the amount of money stolen from federal and state governments by fraudsters.

As noted above, the specific illustrative examples discussed above are but illustrative examples of implementations of embodiments of the method or process for facilitating identification of fraudulent tax filing patterns receives. Those of skill in the art will readily recognize that other implementations and embodiments are possible. Therefore the discussion above should not be construed as a limitation on the claims provided below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for facilitating identification of fraudulent tax filing patterns, the method comprising:
receiving, with a data acquisition module of the computing system, tax return data related to a plurality of previously filed tax returns;
providing, with the data acquisition module, the tax return data to a visualization generation engine;
receiving, with a technician interface module of the computing system, visualization parameter data from a technician;
providing, with the technician interface module, the visualization parameter data to the visualization generation module;
generating, with a visualization generation module of the computing system, visualization data for a visual representation of relationships in the tax return data based on the visualization parameter data; and
outputting, with the technician interface module, the visualization data.

2. The method of claim 1 wherein the tax return data includes one or more of the following:
social security numbers;
user identifications;
home addresses;
business addresses;
tax return filing dates;
IP addresses;
device identifications;
first names;
last names;
state of filing;
bank account numbers;
credit card numbers;
email addresses; and
phone numbers.

3. The method of claim 1 wherein the tax return data includes bank accounts associated with tax refund disbursement requests.

4. The method of claim 1 wherein the visual representation indicates relationships in the tax return data with lines extending between nodes representing the tax return data points.

5. The method of claim 4 wherein the visualization parameter data includes selected categories of tax return data.

6. The method of claim 1 including:
receiving, with a user interface module of the computing system, user data for a current tax return; and
detecting fraud in the user data by monitoring the user data with a fraud detection module of the computing system.

7. The method of claim 6 wherein monitoring the user data includes comparing the user data to fraud alert parameter data stored in the fraud detection module.

8. The method of claim 7 comprising:
receiving, with the technician interface module, updated fraud alert parameter data based on the visualization data; and
updating the fraud alert parameter data with the updated fraud alert parameter data.

9. The method of claim 1 wherein the data acquisition module retrieves the tax return data from a financial service provider system.

10. The method of claim 1 wherein the tax return preparation system retrieves the tax return data from the additional service provider system.

11. The method of claim 1 wherein the data acquisition module retrieves the tax return data from a third party computing environment.

12. The method of claim 1 wherein the data acquisition module retrieves the tax return data from a common database of the computing system.

13. The method of claim 1 wherein the data acquisition module combines the tax return data into a single database.

14. The method of claim 13 wherein the data acquisition module combines provides the single database to the visualization generation module.

15. The method of claim 1 including:
periodically retrieving, with the data acquisition module, additional tax return data;
providing the additional tax return data from the data acquisition module to the visualization generation module; and
generating the visualization data based on the additional tax return data.

16. A non-transitory computer-readable medium having a plurality of computer-executable instructions which, when executed by a processor, perform a method facilitating identification of fraudulent tax filing patterns, the instructions comprising:
a data acquisition module configured to retrieve tax return data, the tax return data being related to previously filed tax returns;
a technician interface module configured to receive visualization parameter data from a technician; and
a visualization generation module configured to generate visualization data based on the tax return data and the visualization parameter data, the visualization data corresponding to a visual representation of relationships in the tax return data in accordance with the visualization parameters.

17. The non-transitory computer-readable medium of claim 16 wherein the technician interface module is configured to output the visualization data to a technician computing environment.

18. The non-transitory computer-readable medium of claim 16 wherein the tax return data includes bank account data associated with tax refund disbursement requests.

19. The non-transitory computer-readable medium of claim 17 wherein the tax return data includes social security numbers, user identifications, and tax filing identifications.

20. The non-transitory computer-readable medium of claim 19 wherein the visualization data indicates relationships between the bank account data and one or more of the social security numbers, user identifications, and tax filing identifications in accordance with the visualization parameter data.

21. The non-transitory computer-readable medium of claim 20 wherein the visualization data represents the bank account data, the social security numbers, the user identifications, and the tax filing identifications as nodes, and relationships as lines connecting related nodes.

22. A system for facilitating identification of fraudulent tax filing patterns, the system comprising:
at least one processor; and
at least one memory coupled to the at least one processor, the at least one memory having stored therein instructions which, when executed by any set of the one or more processors, perform a process including:
receiving, with a data acquisition module of the computing system, tax return data related to a plurality of previously filed tax returns;
receiving, with a technician interface module of the computing system, visualization parameter data from a technician;
generating, with a visualization engine of the computing system, visualization data for a visual representation of relationships in the tax return data based on the visualization parameter data; and
outputting, with the technician interface module, the visualization data.

23. The system of claim 22 wherein the tax return data includes one or more of the following:
social security numbers;
user identifications;
home addresses;
business addresses;
tax return filing dates;
IP addresses;
device identifications;
first names;
last names;
bank accounts;
credit card numbers;
state of filing;
email addresses; and
phone numbers.

24. The system of claim 22 wherein the tax return data includes bank accounts associated with tax refund deposits.

25. The system of claim 24 wherein the visual representation indicates relationships between bank accounts and previously filed tax returns with lines extending between nodes representing the tax return data.

26. The system of claim 25 wherein the visualization parameter data includes categories of tax return data.

27. The system of claim 22 wherein the process includes:
receiving, with a user interface module of the computing system, user data for a current tax return; and
detecting fraud in the user data by monitoring the user data with a fraud detection module of the computing system.

28. The system of claim 27 wherein monitoring the user data includes comparing the user data to fraud alert parameter data stored in the fraud detection module.

29. The system of claim 28, wherein the method includes:
receiving, with the technician interface module, updated fraud alert parameter data based on the visualization data; and
updating the fraud alert parameter data with the updated fraud alert parameter data.

30. The method of claim 22 wherein the data acquisition module retrieves the tax return data from a financial service provider system.

31. The system of claim 22 wherein the tax return preparation system retrieves the tax return data from an additional service provider system.

32. The system of claim 23 wherein the data acquisition module retrieves the tax return data from a third party computing environment.

33. The system of claim 22 wherein the data acquisition module retrieves the tax return data from a common database of the computing system.

34. The system of claim 22 wherein the data acquisition module combines the tax return data into a single database.

35. The system of claim 34 wherein the data acquisition module provides the single database to the visualization generation module.

36. The system of claim 22 wherein the process includes providing the tax return data from the data acquisition module to the visualization generation module.

37. The system of claim 22 wherein the method includes periodically retrieving, with the data acquisition module, additional tax return data.

38. The system of claim 37 wherein the process includes providing the additional tax return data from the data acquisition module to the visualization generation module.

39. The system of claim 38 wherein the process includes generating the visualization data based on the additional tax return data.
